(19) United States
(12) Patent Application Publication
(10) Pub. No.: US 2026/0179865 A1
(43) Pub. Date: Jun. 25, 2026

(54) SELF-BLAST CIRCUIT BREAKER AND AUXILIARY NOZZLE THEREFOR

(71) Applicant: Mitsubishi Electric Power Products, Inc., Warrendale, PA (US)

(72) Inventor: Paul J. Vladuchick, Cranberry Township, PA (US)

(73) Assignee: Mitsubishi Electric Power Products, Inc., Warrendale, PA (US)

(21) Appl. No.: 18/990,639

(22) Filed: Dec. 20, 2024

(51) Int. Cl. H01H 33/90; H01H 33/91

(52) U.S. Cl. CPC H01H 33/901; H01H 33/91; H01H 2033/902; H01H 2033/912

(57) ABSTRACT

An auxiliary nozzle for a moving contact structure of a self-blast circuit breaker includes a first end and a second end. The auxiliary nozzle includes a cylindrical body extending from the first end toward the second end and having an outer surface and an inner surface defining a first elongated passage with a first diameter. The auxiliary nozzle also includes a nozzle throat extending from the cylindrical body to the second end and having an inner surface defining a second elongated passage with a second diameter smaller than the first diameter. The cylindrical body defines a plurality of ports extending from the inner surface to the outer surface and arranged proximate to the nozzle throat.

### TECHNICAL FIELD

The present disclosure relates, generally, to self-blast circuit breakers, and, more particularly, relates to an auxiliary nozzle for a self-blast circuit breaker.

### BACKGROUND

A self-blast circuit breaker is a device that helps to prevent unintended currents caused by short circuits in electrical systems. It works by interrupting the current after a fault has been detected, thereby preventing damage to the system. Self-blast circuit breakers rely on an insulation gas, for example, SF₆, to extinguish the arc created when the circuit is tripped and the contacts move apart.

Conventional dead tank self-blast circuit breakers typically include a dead tank and an interrupter unit arranged inside the dead tank with an insulation gas filled inside the dead tank. To facilitate an opening and closing of an electric circuit, the circuit breaker typically includes a stationary contact structure having a main stationary contact and a stationary arc contact arranged coaxially and inside the main stationary contact. Further, the self-blast circuit breaker includes a moving contact structure that moves, back and forth, relative to the stationary contact structure to enable an electrical engagement and disengagement between two electrical conductors/equipment. The moving structure includes a moving main contact that engage with the stationary main contact, and a moving arc contact that connects with the stationary arc contact. It may be noted that the electrical arcing takes place between the moving arc contact and the stationary arc contact as the moving contact structure is displaced/moved to open the circuit breaker.

Also, the self-blast circuit breaker includes a puffer cylinder having puffer chamber filled with insulation gas (SF6) and a thermal expansion chamber to receive the insulation gas from the puffer chamber. Moreover, the self-blast circuit includes a main nozzle and an auxiliary nozzle arranged inside the main nozzle defining a channel therebetween. As the moving contact structure is retracted to open the circuit breaker, the insulation gas inside the puffer chamber is compressed which causes the insulation gas to flow to the thermal expansion chamber from the puffer chamber. Moreover, as the moving structure is retracted i.e., moved away from the stationary contacts, the moving arc contact disengages from the stationary arc contact, and an electric arc develops between the two arc contacts with the tip of the moving arc contact still presents inside the auxiliary nozzle. Due to the electrical arc, heat is generated. Upon further retraction, the channel is opened and heat energy increases the temperature and pressure of the insulation gas present inside the thermal expansion chamber. The highly pressurized insulation gas flows to the main nozzle from the thermal expansion chamber via the channel once the pressure inside the thermal expansion chamber reaches above a threshold inside the main nozzle, and extinguish the electrical arc. Before opening of the channel, the heat energy generated due to the electrical arc is essentially wasted and vented down an exhaust tube, resulting into longer electric arc duration that causes deterioration of the contacts, reducing the life of the contacts.

### SUMMARY

Accordingly, one object of the present disclosure is to reduce the arcing time and quickly extinguishing the arc generated between the stationary arc contact and moving arc contact of the self-blast circuit breaker. Another object of the present disclosure is to utilize the heat generated due to the generation of the arc as well as heat generated during disengagement of the stationary arc contact and moving arc contact to increase the pressure of the insulation gas to increase the velocity of the insulation gas entering the main chamber to quicky extinguish the arcing time.

The above objects are addressed by an auxiliary nozzle having a plurality of ports that allows flow of heated gas heated by the electric arc to move to the thermal expansion chamber even before the outlet of the channel is opened.

Generally, in one aspect, the present disclosure relates to an auxiliary nozzle for a moving contact structure of a self-blast circuit breaker is disclosed. The auxiliary nozzle has a first end, a second end, and a cylindrical body extending from the first end toward the second end. The cylindrical body has an outer surface and an inner surface defining a first elongated passage having a first diameter. Moreover, the auxiliary nozzle includes a nozzle throat extending from the cylindrical body to the second end and having an inner surface defining a second elongated passage having a second diameter smaller than the first diameter. The cylindrical body defines a plurality of ports extending from the inner surface to the outer surface and arranged proximate to the nozzle throat.

In another aspect, the disclosure relates to a self-blast circuit breaker includes a stationary contact structure, and a moving contact structure arranged to move in a longitudinal direction to engage and disengage with the stationary contact structure. The moving contact structure includes a puffer cylinder having a first end and a second end and defining a puffer chamber. A thermal expansion chamber is arranged between the first end and the puffer chamber and fluidly coupled to the puffer chamber to receive insulation gas from the puffer chamber. The moving contact structure also includes a primary nozzle extending outwardly in the longitudinal direction from the first end of the puffer cylinder and arranged coaxially to the puffer cylinder. Moreover, the moving contact structure includes an auxiliary nozzle arranged inside the primary nozzle and defining a channel therebetween. The auxiliary nozzle extends outwardly in the longitudinal direction from the first end of the puffer cylinder and includes a first end coupled to the puffer cylinder and a second end arranged distally from the puffer cylinder and inside the primary nozzle. The auxiliary nozzle includes a cylindrical body extending from the first end of the auxiliary nozzle towards the second end. The cylindrical body has an outer surface and an inner surface defining a first elongated passage with a first diameter. The auxiliary nozzle also includes a nozzle throat extending from the cylindrical body to the second end. The nozzle throat includes an inner surface defining a second elongated passage having a second diameter smaller than the first diameter. The cylindrical body defines a plurality of ports extending from the inner surface to the outer surface and arranged proximate to the nozzle throat. The plurality of ports allows a flow of heated insulation gas from an inside of the auxiliary nozzle to the thermal expansion chamber through the channel.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 illustrates a front sectional view of a self-blast circuit breaker, in accordance with an embodiment of the disclosure;

FIG. 2 illustrates an enlarged view of a portion of the self-blast circuit breaker of FIG. 1 depicting the moving contact structure arranged disengaged and away a stationary contact structure of the self-blast circuit breaker, in accordance with an embodiment of the disclosure;

FIG. 3 illustrates an enlarged view of the self-blast circuit breaker depicting the moving contact structure arranged in contact the with the stationary contact structure, in accordance with an embodiment of the disclosure;

FIG. 4 illustrates a front perspective view of an auxiliary nozzle of the self-blast circuit breaker of FIG. 1, in accordance with an embodiment of the disclosure;

FIG. 5 illustrates a sectional view of the auxiliary nozzle of FIG. 4 depicting ports arranged at an inclination relative to a central axis of the auxiliary nozzle, in accordance with an embodiment of the disclosure;

FIG. 6 illustrates a front perspective view of an auxiliary nozzle of the self-blast circuit breaker having ports arranged in an inline arrangement between two rows, in accordance with an embodiment of the disclosure;

FIG. 7 illustrates a front perspective view of an auxiliary nozzle of the self-blast circuit breaker having ports arranged in a staggered arrangement between two rows, in accordance with an embodiment of the disclosure, in accordance with an embodiment of the disclosure; and

FIG. 8 illustrates a sectional view of an auxiliary nozzle depicting ports arranged perpendicularly to a central axis of the auxiliary nozzle, in accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

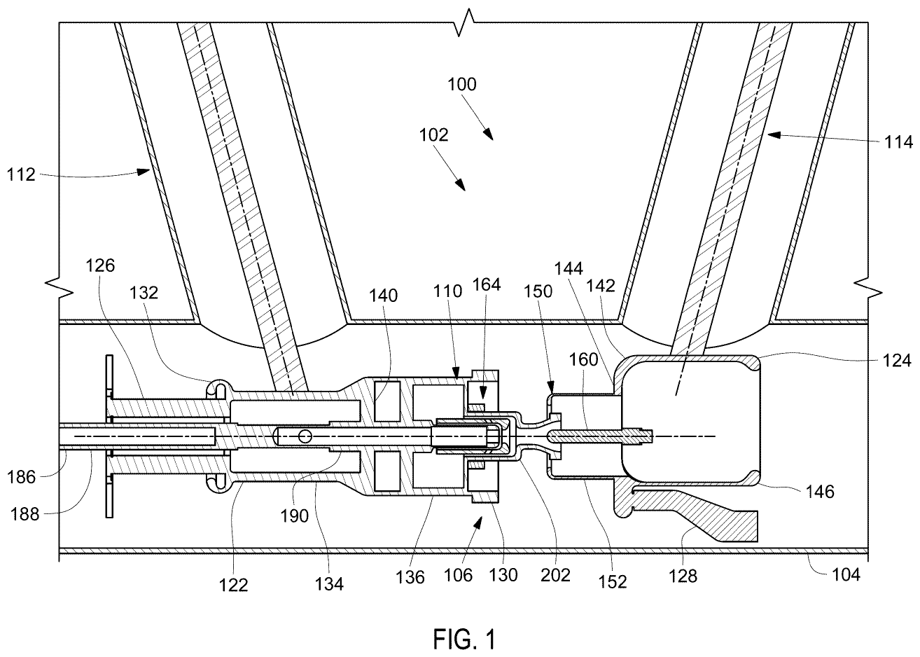

Referring to FIG. 1, a self-blast circuit breaker 100 is shown, according to various embodiments of the present disclosure. The self-blast breaker 100 is illustrated as a dead tank circuit breaker 102, however, other types of self-blast circuit breakers are also suitable in conjunction with the present disclosure and concepts described herein. As shown, the self-blast circuit breaker 100 (hereinafter referred to as breaker 100) includes a dead tank 104 defining a chamber 106, an interrupter unit 110 arranged inside the chamber 106 and supported on the dead tank 104, and a pair of conductors 112, 114 attached to the interrupter unit 110 to electrically couple a first electric equipment and a second electrical equipment. The interrupter unit 110 is arranged to electrically connect and disconnect the first and second electrical equipment and includes, a first casing 122, a second casing 124, and a pair of ground contacts 126, 128 supporting the interrupter unit 110 on the dead tank 104 and electrically insulating the dead tank 104 from electrically conducting components of the interrupter unit 110.

The first casing 122 and the second casing 124 are formed of electrically conducing material, for example, aluminium, or any other electrically conducting metal or alloy known in the art. A first conductor 112 of the pair of conductors 112, 114 is attached to the first casing 122, while a second conductor 114 of the pair of conductors 112, 114 is attached to the second casing 124, and the first conductor 112 and the second conductor 114 extend outwardly of the dead tank 104 from the associated casings 122, 124.

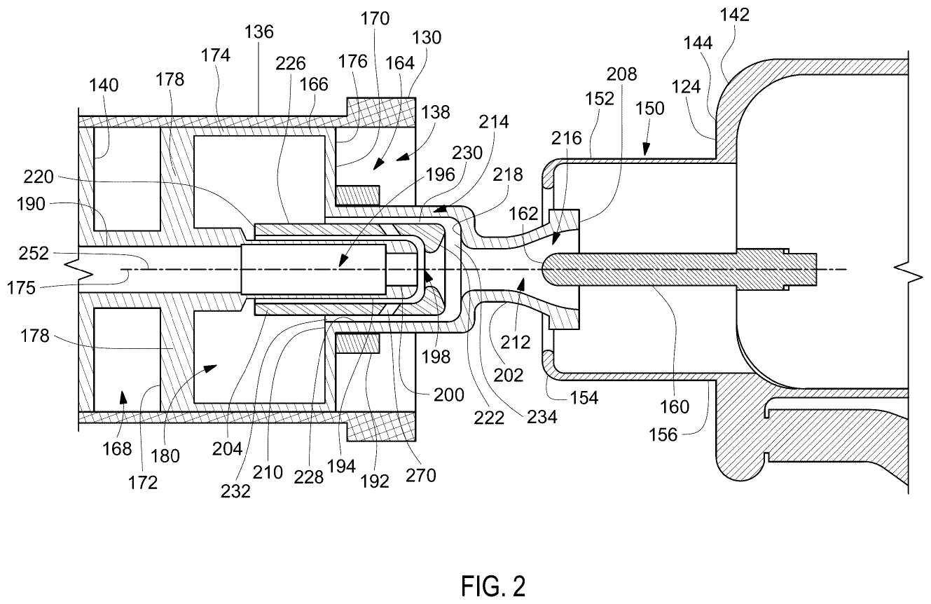

As shown in FIG. 1, the first casing 122 includes a first end 130 arranged proximate to the second casing 124 and a second end 132 arranged opposite to the first end 130 and disposed connected to a first ground contact 126 of the pair of ground contacts. The first casing 122 includes a first enclosure 134, also referred to the as a moving side exhaust enclosure 134, extending from the second end 132 towards the first end 130, and a frame 136, also referred to as moving side interrupter frame 136, extending from the first enclosure 134 to the first end 130 of the first casing 122. It may be appreciated that the frame 136 is hollow frame 136 and includes a substantially hollow cylindrical shape with an opening 138, shown in FIG. 2, of the frame 136 arranged at the first end 130 of the first casing 122. The first enclosure 134 is also a hollow enclosure and the first conductor 112 is connected to the first enclosure 134. A separation wall 140 separates the frame 136 from the first enclosure 134 and extends in a direction substantially perpendicular to an axial direction i.e., longitudinal direction of the interrupter unit 110.

Further, the second casing 124 includes a second enclosure 142 having a substantially hollow cylindrical shape with a first end 144, shown in FIG. 2, arranged facing the first end 130 of the first casing 122, and a second end 146 disposed proximate to an axial end of the dead tank 104 and opposite to the first end 144. The second casing 124 is supported on and connected to the dead tank 104 via the second ground contact 128. The second enclosure 142 includes a slot and an end portion of the second conductor 114 is arranged inside the slot and is attached to the second enclosure. The second conductor 114 extends from the slot and outwardly of the dead tank 104.

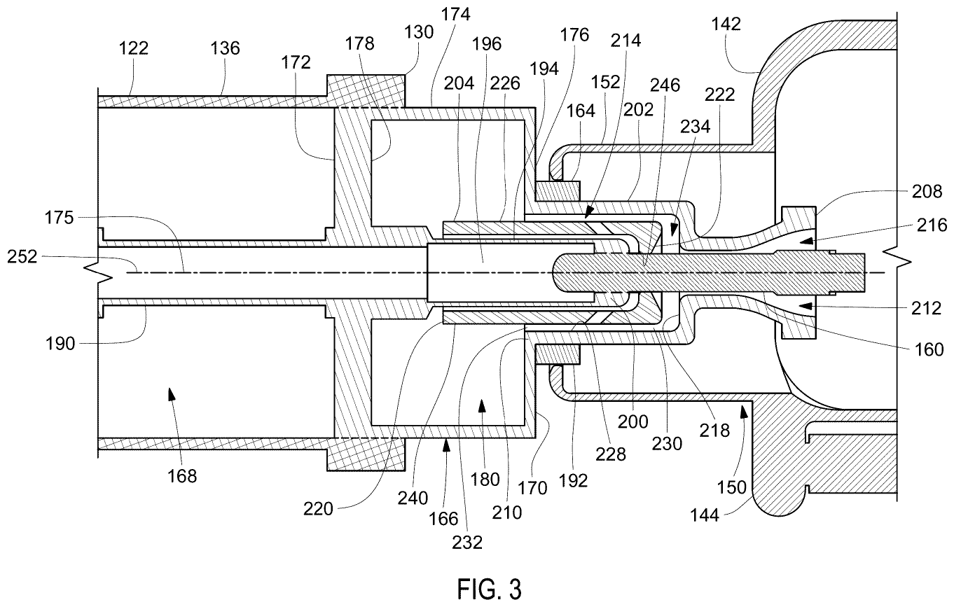

Also, referring to FIGS. 2 and 3, the interrupter unit 110 includes a first contact structure 150, also referred to as stationary contact structure 150, attached to the second casing 124 i.e., second enclosure 142, and extending in the longitudinal direction towards the first casing 122 from the first end 144 of the second enclosure 142. As shown, the first contact structure 150 includes a stationary main contact 152 arranged coaxially to the second enclosure 142 and having a first end 154 arranged outwardly of the second enclosure 142 and a second end 156 arranged connected to the first end 144 of the second enclosure. The stationary main contact 152 includes a substantially hollow cylindrical shape defining a hollow interior, and may include an outer and inner diameters that are smaller than an outer and inner diameters of the second enclosure 142.

Moreover, the first contact structure 150 includes a stationary arc contact 160 attached to the second casing 124 and extending outwardly from the second casing 124 in the longitudinal direction towards the first casing 122. As shown, the stationary arc contact 160 includes a substantially rod shape extending inside the hollow interior of the stationary main contact 152 and disposed substantially centrally to the stationary main contact 152. In some embodiments, a tip end 162 of the stationary arc contact 160 may extend outwardly of the stationary main contact 152 in the longitudinal direction. Alternatively, the tip end 162 may be arranged inside the stationary main contact 152. It may be noted that the stationary main contact 152 and the stationary arc contact 160, each is made of electrically conductive material.

Furthermore, as shown in FIGS. 2 and 3, the interrupter unit 110 includes a second contact structure 164, also referred to as a moving contact structure 164, movably coupled to the frame 136 and adapted to move relative to the frame 136 in the axial/longitudinal direction. As shown, the moving contact structure 164 includes a puffer cylinder 166 slidably coupled to the frame 136 and at least partially arranged inside the frame 136. The puffer cylinder 166 is adapted to slide between a first position, i.e., retracted position and a second position i.e., extended position relative to the frame 136 and defines a puffer chamber 168 between the frame 136 and the puffer cylinder 166. A volume of the puffer chamber 168 is minimum when the puffer cylinder 166 is arranged at the retracted position and is maximum when the puffer chamber 168 is disposed at the extended position. It may be appreciated that at the extended position, the moving contact structure 164 is connected to the stationary contact structure 150, while at the retracted position, the moving contact structure 164 is arranged disengaged/disconnected from the stationary contact structure 150.

As shown in FIG. 2, the puffer cylinder 166 is arranged coaxially to the frame 136 and includes a first end 170 arranged distally from the separation wall 140 and a second end 172 disposed proximally to the separation wall 140. The puffer cylinder 166 includes a substantially cylindrical wall 174 extending circularly around a central axis 175 of the puffer cylinder 166, contacting an inner surface of the frame 136, a first end wall 176 arranged at the first end 170 and extending substantially perpendicularly to the central axis of the puffer cylinder, and second end wall 178 arranged at the second end 172 and disposed facing the separation wall 140. Accordingly, a thermal chamber 180 is defined between the cylindrical wall 174 and the two end walls 176, 178 i.e., between the puffer chamber 168 and the first end 170 of the puffer cylinder 166. The second end wall 178 defines an opening 182 that is arranged at a radial offset from the central axis of the puffer cylinder 166 to allow an exchange of insulating gas between the puffer chamber 168 and the thermal chamber 180 as the puffer cylinder 166 is moved between the extended position and the retracted position. A valve 184 is positioned at the opening 182 to selectively open and close the opening 182 based on the pressure of the gas inside the puffer chamber 168.

To move the puffer cylinder 166 i.e., the moving contact structure 164, the interrupter unit 110 includes an actuator 186 having an actuator rod 188 extending from an outside of the interrupter unit 110 to an inside of the first enclosure 134 through the first ground contact 126 and an exhaust tube 190 extending from the actuator rod 188, shown in FIG. 1, to the puffer cylinder 166 and connected to the puffer cylinder 166. Accordingly, by axially moving the actuator rod 188, the puffer cylinder 166, and hence the moving contact structure 164, is displaced in the longitudinal direction to enable the engagement and the disengagement of the moving contact structure 164 with the stationary contact structure 150.

Moreover, the moving contact structure 164 includes a moving main contact 192 arranged circularly around the central axis of the puffer cylinder 166 and extending outwardly in the axial/longitudinal direction from the first end 170 i.e., first end wall 176 of the puffer cylinder 166. As shown, the moving main contact 192 is arranged radially inward of the circular wall 174 of the puffer cylinder 166. The moving main contact 192 is made of electrically conducting material, and is arranged to contact the stationary main contact 152. Additionally, the moving contact structure 164 includes a moving arc contact 194 arranged substantially centrally to the puffer cylinder 166 and attached to the puffer cylinder 166 such that at least a portion of the moving arc contact 194 extends outwardly of the first end 170 of the puffer cylinder 166 in the longitudinal direction. As shown, the moving arc contact 194 includes substantially hollow cylindrical shape defining a cavity 196 and an opening 198 of the cavity 196 arranged at a free end of the moving arc contact 194. Also, the moving arc contact 194 is arranged in fluid communication i.e., fluidly coupled to the exhaust tube 190. The stationary arc contact 160 is configured to extend inside the cavity 196 through opening 198 and contacts the moving arc contact 160 to establish an electrical connection with the moving arc contact 160.

As shown, the moving arc contact 194 includes inwardly extending flange 200 extending radially inwardly from an inner surface of a hollow cylindrical wall of the moving arc contact 194. It may appreciated that an outer surface of the stationary arc contact 160 engages with the flange 200 that is arranged the free end of the moving arc contact 194. The moving arc contact 194 is made of a suitable electrically conducting material, for example, aluminium, aluminium alloy, copper, copper alloy, or any other such material known in the art.

Furthermore, the moving contact structure 164 includes a first nozzle 202, also referred to as primary nozzle 202, and a second nozzle 204, also referred to auxiliary nozzle 204, arranged connected to the puffer cylinder 166 and at least partially extending outwardly of the first end 170 of the puffer cylinder 166 in the longitudinal direction. As shown in FIGS. 2 and 3, the primary nozzle 202 is arranged coaxially to the moving main contact 192 and the moving arc contact 194, and is arranged between the moving main contact 192 and the moving arc contact 194 in a radial direction. As shown in FIG. 2, a first end 208 of the primary nozzle 202 is arranged outwardly of the moving main contact 192 in the longitudinal direction, while a second end 210 of the primary nozzle 202 is connected to the first end wall 176 of the puffer cylinder 166. A length of the primary nozzle 202 is selected such that the first end 208 of the primary nozzle 202 is arranged proximate to the stationary main contact 152 and may be arranged inside the stationary main contact 152 with the stationary arc contact 160 may extending inside the primary nozzle 202. As shown, the primary nozzle 202 defines an elongated conduit 212 extending from the first end 208 to the second end 210. The elongated conduit 212 includes a first conduit portion 214 extending from the second end 210 towards the first end 208 and having a substantially constant diameter, a second conduit portion 216 extending from first conduit portion 214 to the first end 208 and having convergent shape from the first end 208 to the first conduit portion 214. Accordingly, a step 218 is defined at an interface of the first conduit portion 214 and the second conduit portion 216.

Further, the second nozzle 204 i.e., auxiliary nozzle 204, is arranged coaxially to the main arc contact 194 and includes a hollow interior in which the moving arc contact 194 extends. The auxiliary nozzle 204 is arranged between the primary nozzle 202 and the moving arc contact 194 in the radial direction and may be engaged to the moving arc contact 194 and/or the puffer cylinder 166. Referring to FIG. 3, the auxiliary nozzle 204 includes a first end 220 attached to the moving arc contact 194 and a second end 222 that extends outwardly of the free end of the moving arc contact 194 in the longitudinal direction. The second end 222 is arranged inwardly of the step 218 of the primary nozzle 202. Further, an outer surface 226 of the auxiliary nozzle 204 is arranged at a radial offset from an inner surface 228 of the primary nozzle 202 defining a channel 230 therebetween with an inlet 232 of the channel 230 defined at the first end 170 the puffer cylinder 166 to allow an entry of the insulation gas inside the channel 230 from the thermal chamber 180. Moreover, an outlet 234 of the channel 230 is defined between the step 218 of the primary nozzle 202 and the first end 220 of the auxiliary nozzle 204, and the insulation gas enters the second conduit portion 216 through the outlet 234.

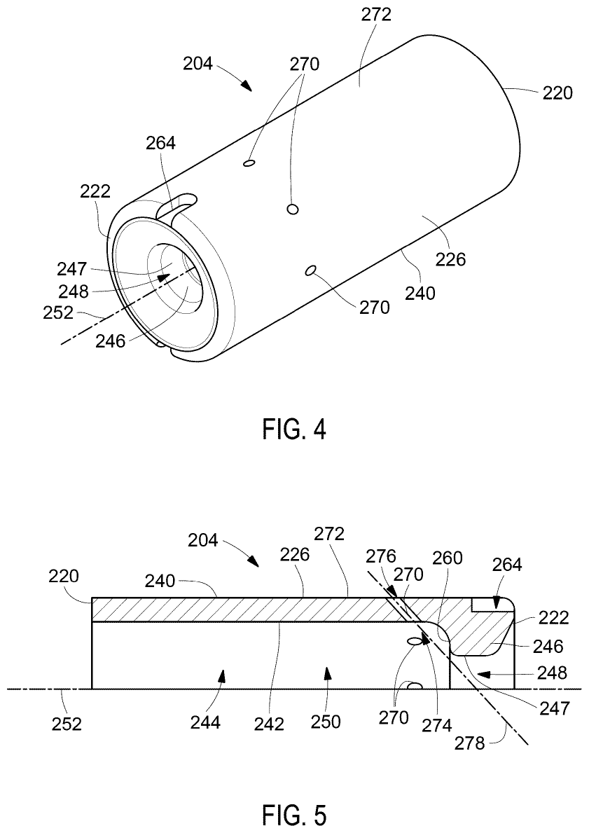

Referring to FIGS. 4 and 5, the auxiliary nozzle 204 includes a cylindrical body 240 having an inner surface 242 defining a first elongated passage 244, and a nozzle throat 246 having an inner surface 247 defining a second elongated passage 248. The first elongated passage 244 and the second elongated passage 248 together defines the hollow interior 250 of the auxiliary nozzle 204. As shown, the cylindrical body 240 is arranged circularly around a central axis 252 of the auxiliary nozzle 204 that coincides with the central axis of the puffer cylinder 166. The cylindrical body 240 extends from the first end 220 of the auxiliary nozzle 204 to the nozzle throat 246 in the longitudinal direction. As shown in FIG. 3, the moving arc contact 194 is arranged completely inside the first elongated passage 244. Further, referring again to FIGS. 4 and 5, the nozzle throat 246 is arranged circularly around the central axis 252 of the auxiliary nozzle 204 and extends, in the longitudinal direction, from the cylindrical body 240 to the second end 222 of the auxiliary nozzle 204. Further, a diameter of the first elongated passage 244 is larger than a diameter of the second elongated passage 248, accordingly, a step 260 is defined at an interface of the cylindrical body 240 and the throat portion 246. The moving arc contact 194 is arranged inside the auxiliary nozzle 205 such that the free or tip end of the moving arc contact 194 is disposed inwardly and at an offset from the step 260 in the longitudinal direction, defining a gap 262, best shown in FIG. 2, therebetween. In some embodiment, an outer surface of the nozzle throat 246 defines at least one notch 264 arranged at the second end 222 of the auxiliary nozzle 204.

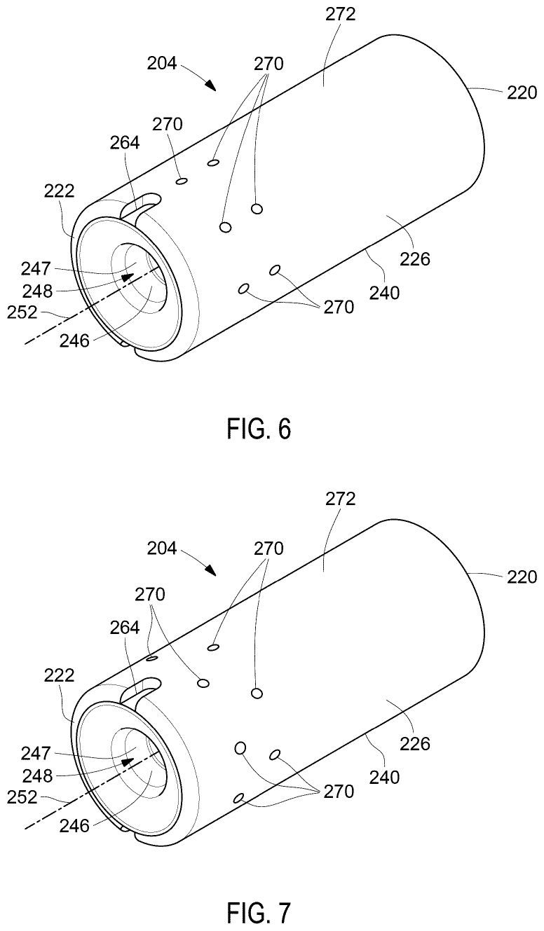

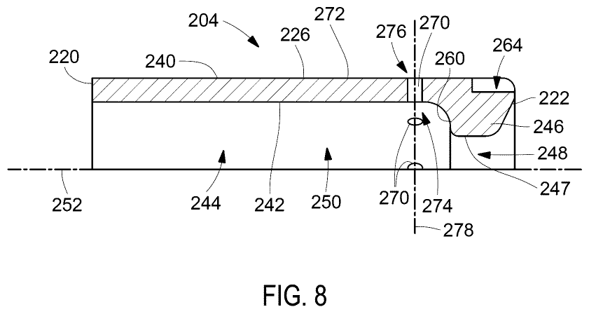

Additionally, the cylindrical body 240 defines a plurality of ports 270 extending from the inner surface 242 of the cylindrical body 240 to an outer surface 272 of the cylindrical body 240. The ports 270 are arranged proximate to the nozzle throat 246 i.e., inwardly of the step 260 with a first opening 274, shown in FIG. 5, of each port 270 arranged at the inner surface 242 and a second opening 276, shown in FIG. 5, of each port 270 arranged at the outer surface 272. As shown in FIG. 5, a central axis 278 of each of the plurality of ports 270 is arranged at an inclination relative to the central axis 252 of the auxiliary nozzle 204. In some embodiments, the angle of inclination of each port 270 lies 25 degrees and 60 degrees. As illustrated in FIG. 5, the first openings 274 of the ports 270 are arranged proximate to the nozzle throat 246 i.e., the step 260, while the second openings 276 of the ports 270 are disposed distally from the nozzle throat 246 i.e., step 260 relative to the first openings 274. In the embodiment, shown in FIG. 4, the plurality of ports 270 are arranged in a single circular row. However, the plurality of ports 270 may be arranged in multiple circular rows, as shown in FIGS. 6 and 7. The ports 270 in multiple rows may be arranged either in an inline arrangement, as shown in FIG. 6, or in a staggered arrangement, as shown in FIG. 7. In some embodiments, as shown in FIG. 8, the central axis 278 of the ports 270 extends substantially perpendicularly to the central axis 252 of the auxiliary nozzle 204.

The ports 270 facilitates in the exchange of the insulation gas between the channel 230 and the hollow interior 250 of the auxiliary nozzle 204. The plurality of ports 270 allows a flow of heated insulation gas from an inside of the auxiliary nozzle 204 to the thermal expansion chamber 180 through the channel 230, when the stationary arc contact 160 is arranged closing the outlet 234 of the channel 230 and upon disengagement of the moving arc contact 194 from the stationary arc contact 160. The heated gas heats the insulation gas present inside the thermal expansion chamber 180 and increases the pressure of the thermal expansion chamber 180, resulting into a higher pressure in the thermal expansion chamber 180 earlier in the travel of the moving contact structure 164 away from the stationary contact structure 150. Accordingly, when the moving arc contact 194 is arranged away from stationary arc contact 160 such that the outlet 234 of the channel 230 is open, the insulation gas quickly moves inside the primary nozzle 202, resulting in a less total arcing time required for a successful interruption, and a longer arc contacts life.

Also, the insulation gas enters inside the hollow interior 250 through the ports 270 enables a shortening of length of the electric arc generated between the stationary arc contact 160 and the moving arc contact 194 upon disengagement of the stationary and moving arc contacts 160, 194, shortening of the time duration required for extinguishing the electric arc.

Example Embodiment: Auxiliary nozzle for self-blast circuit breaker: Referring to FIGS. 4 and 5, the auxiliary nozzle 204 for the self-blast circuit breaker 100 is shown. The auxiliary nozzle 204 includes the first end 220, the second end 220, and a cylindrical body 240 extending from the first end 220 toward the second end 222. The cylindrical body 240 has the outer surface 272 and the inner surface 242, shown in FIG. 5, that defines a first elongated passage 244, shown in FIG. 5, having a first diameter. The auxiliary nozzle 204 also includes a nozzle throat 246 that extends from the cylindrical body 240 to the second end 222. The nozzle throat 246 has an inner surface 247 defining a second elongated passage 248 and having a second diameter smaller than the first diameter. The cylindrical body 240 defines a plurality of ports 270 extending from the inner surface 242 to the outer surface 272, and arranged proximate to the nozzle throat 246.

As illustrated in FIG. 3, the ports 270 facilitate a transfer of the heated gas, generated during the disengagement of the stationary arc contact 160 from the moving arc contact 194 to the thermal expansion chamber 180 of the self-blast circuit breaker 100. The heated gas heats the insulation gas present inside the thermal expansion chamber 180 and increases the pressure inside the thermal expansion chamber 180, resulting into a higher pressure in the thermal expansion chamber 180 earlier in the travel of the moving contact structure 164 of the self-blast circuit 100 away from the stationary contact structure 150. This results in a less total arcing time required for a successful interruption, and a longer arc contacts life. In some embodiments, the ports 270 are arranged proximate to the step 260 defined at an interface of the cylindrical body 240 and the nozzle throat 246 causing the flow of heated gas early during the generation of the arc.

In some additional, optional, alternative embodiment, the plurality of ports 270 is arrayed circularly around the central axis 252 of the auxiliary nozzle 204. In some embodiments, as shown in FIG. 8, the central axis 278 of each of the plurality of ports 270 extends perpendicularly to the central axis 252 of the auxiliary nozzle 204.

In some embodiments, as shown in FIG. 5, the central axis 278 of each of the plurality of ports 270 is arranged at an inclination relative to the central axis 252 of the auxiliary nozzle 204. The angle of inclination between the central axis 278 of the port 270 and the central axis 252 of the auxiliary nozzle 204 is between 25 degrees and 60 degrees. In some embodiments, as shown in FIG. 5, the inner surface 242 of the cylindrical body 240 defines a first opening 274 of each port 270 and the outer surface 272 of the cylindrical body 240 defines a second opening 276 of each port 270. The first opening 274 is arranged proximate to the nozzle throat 246 than the second opening 276. Such orientation of the ports 270 directs the heated gas from an inside of the auxiliary nozzle 204 to the thermal expansion chamber 180.

In some embodiments, the plurality of ports 270 is arranged in a single row, as shown in FIG. 4. In some embodiments, the plurality of ports 270 is arranged in at least two rows, shown in FIGS. 6 and 7. In some embodiments, the plurality of ports 270 is arranged in a staggered arrangement in the at least two rows, shown in FIG. 7. In some embodiments, the plurality of ports 270 is arranged in an in-line arrangement in the at least two rows, as shown in FIG. 6.

Example Embodiment: Self-blast circuit breaker: Referring to FIGS. 1 to 3, the self-blast circuit breaker 100 is shown. The self-blast circuit breaker 100 includes the stationary contact structure 150 and the moving contact structure 164 arranged to move in a longitudinal/axial direction to engage and disengage with the stationary contact structure 150. As best shown in FIGS. 2 and 3, the moving contact structure 150 includes the puffer cylinder 166 having the first end 170 and the second end 172 and defining a puffer chamber 168 and a thermal expansion chamber 180 arranged between the first end 170 of the puffer cylinder 166 and the puffer chamber 168. The thermal expansion chamber 180 is fluidly coupled to the puffer chamber 168 to receive insulation gas from the puffer chamber 168.

In some embodiments, the valve 184 is arranged between the thermal expansion chamber 180 and the puffer chamber 168 to control a flow the insulation gas from the puffer chamber 168 to the thermal expansion chamber 180. The insulation gas flow from the puffer chamber 168 to the thermal expansion chamber 180 in response to the compression of the insulation gas inside the puffer chamber 180 above a predefined value. The insulation gas is compressed in response to the movement of the moving contact structure 164 away from the stationary contact structure 150 to disengage the moving contact structure 164 from the stationary contact structure 150.

Further, the moving contact structure 164 includes the primary nozzle 202 extending outwardly in the longitudinal direction from the first end 170 of the puffer cylinder 166 and arranged coaxially to the puffer cylinder 166. Moreover, the moving contact structure 150 includes the auxiliary nozzle 204, best shown in FIGS. 2 and 3, arranged inside the primary nozzle 204 defining the channel 230, best shown in FIG. 3, therebetween. The auxiliary nozzle 204 extends, outwardly in the longitudinal direction, from the first end 170 of the puffer cylinder 166 and includes the first end 220 coupled to the puffer cylinder 166 and the second end 220 arranged distally from the puffer cylinder 166 and disposed inside the primary nozzle 204.

As best shown in FIG. 3, the auxiliary nozzle 204 includes the cylindrical body 240 extending from the first end of the auxiliary nozzle 204 towards the second end of the auxiliary nozzle 204. The cylindrical body 240 has the outer surface and the inner surface that defines a first elongated passage 244 having a first diameter. The auxiliary nozzle 204 also includes a nozzle throat 246 extending from the cylindrical body 240 to the second end 222 and having the inner surface defining a second elongated passage 248, shown in FIG. 2, having a second diameter smaller than the first diameter. Accordingly, the step 260, shown in FIG. 2, is defined at an interface of the cylindrical body 240 and the nozzle throat 246. The cylindrical body 240 defines a plurality of ports 270 extending from the inner surface to the outer surface of cylindrical body 240 and arranged proximate to the nozzle throat 246.

The plurality of ports 270 allows a flow of heated insulation gas from an inside of the auxiliary nozzle 204 to the thermal expansion chamber 180 through the channel 230. The heated gas heats the insulation gas present inside the thermal expansion chamber 180 and increases the pressure of the thermal expansion chamber 180, resulting into a higher pressure inside the thermal expansion chamber 180 earlier in the travel of the moving contact structure 164 away from the stationary contact structure 150. Accordingly, when the moving contact structure 164 is arranged away from stationary contact structure 150 such that the outlet 234 of the channel 230 is open, the insulation gas moves inside the primary nozzle 204 quickly, resulting in a less total arcing time required a successful interruption, and a longer arc contacts life. In some embodiments, the ports 270 are arranged proximate to the step 260 defined at an interface of the cylindrical body 240 and the nozzle throat 246.

In some additional, optional, alternative embodiment, the plurality of ports 270 is arrayed circularly around the central axis 252 of the auxiliary nozzle 204. In some embodiments, as shown in FIG. 8, the central axis 252 of each of the plurality of ports 270 extends perpendicularly to the central axis 278 of the auxiliary nozzle 204.

In some embodiments, the central axis of each of the plurality of ports 270 is arranged at an inclination relative to the central axis of the auxiliary nozzle 204, as shown in FIG. 3. The angle of inclination between the central axis of the port 270 and the central axis of the auxiliary nozzle 204 is between 25 degrees and 60 degrees. In some embodiments, as shown in FIG. 3, the inner surface of the cylindrical body 240 defines a first opening of each of the plurality of ports 270 and the outer surface of the cylindrical body 240 defines a second opening of each of the plurality of ports 270. The first opening is arranged proximate to the nozzle throat 246 than the second opening. Such orientation of the ports 270 directs the heated gas from an inside of the auxiliary nozzle 204 to the thermal expansion chamber 180.

In some embodiments, the plurality of ports 270 is arranged in a single row, as shown in FIG. 3. In some embodiments, the plurality of ports 270 is arranged in at least two rows, shown in FIGS. 6 and 7. In some embodiments, the plurality of ports 270 is arranged in a staggered arrangement in the at least two rows, shown in FIG. 7. In some embodiments, the plurality of ports 270 is arranged in an in-line arrangement in the at least two rows, as shown in FIG. 6.

As shown in FIGS. 2 and 3, the stationary contact structure 150 includes a stationary arc contact 160, and the moving contact structure 164 includes a moving arc contact 194 arranged coaxially inside the auxiliary nozzle 204 and having a tip end i.e., flange 200, best shown in FIG. 3, arranged inside the cylindrical body 240 at an offset from the nozzle throat 246. The moving arc contact 194 is adapted to contact and engage with stationary arc contact 160, closing an opening i.e., outlet 234 of the channel 230 defined between the auxiliary nozzle 204 and the primary nozzle 204. The first opening of one or more ports 270 of the plurality of ports is disposed between tip end i.e., the flange 200 of the moving arc contact 194 and nozzle throat 246 in the longitudinal direction. This enables the flow of heated gas to the channel 230 from the auxiliary nozzle 204 upon generation of the arc.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

### LIST OF ELEMENTS

100 self-blast circuit breaker
102 dead tank self-blast circuit breaker
104 dead tank
106 chamber
110 interrupter unit
112 first conductor
114 second conductor
122 first conductor casing
124 second conductor casing
126 first ground contact
128 second ground contact
130 first end
132 second end
134 first enclosure
136 frame
138 opening
140 separation wall
142 second enclosure
144 first end
146 second end
150 stationary contact structure
152 stationary main contact
154 first end
156 second end
160 stationary arc contact
162 tip end
164 moving contact structure
166 puffer cylinder
168 puffer chamber
170 first end
172 second end
174 cylindrical wall
175 central axis
176 first end wall
178 second end wall
180 thermal expansion chamber
182 opening
184 valve
186 actuator
188 actuator rod
190 exhaust tube
192 moving main contact
194 moving arc contact
196 cavity
198 opening
200 flange
202 primary nozzle
204 auxiliary nozzle
208 first end
210 second end
212 elongated conduit
214 first conduit portion
216 second conduit portion
218 step
220 first end
222 second end
226 outer surface
228 inner surface
230 channel
232 inlet
234 outlet
240 cylindrical body
242 inner surface
244 first elongated passage
246 nozzle throat
247 inner surface
248 second elongated passage
250 hollow interior
252 central axis
260 step
262 gap
270 port
272 outer surface
274 first opening
276 second opening
278 central axis

What is claimed is:

1. An auxiliary nozzle for a moving contact structure of a self-blast circuit breaker, the auxiliary nozzle has a first end and a second end, the auxiliary nozzle comprising:
a cylindrical body extending from the first end of the auxiliary nozzle towards the second end of the auxiliary nozzle, the cylindrical body includes an outer surface and an inner surface defining a first elongated passage having a first diameter; and
a nozzle throat extending from the cylindrical body to the second end of the auxiliary nozzle and having an inner surface defining a second elongated passage having a second diameter smaller than the first diameter,
wherein the cylindrical body defines a plurality of ports extending from the inner surface of the cylindrical body to the outer surface of the cylindrical body, wherein the plurality of ports is arranged proximate to the nozzle throat.

2. The auxiliary nozzle of claim 1, wherein the plurality of ports is arrayed circularly around a central axis of the auxiliary nozzle.

3. The auxiliary nozzle of claim 1, wherein a central axis of each of the plurality of ports extends perpendicularly to a central axis of the auxiliary nozzle.

4. The auxiliary nozzle of claim 1, wherein a central axis of each of the plurality of ports is arranged at an inclination relative to a central axis of the auxiliary nozzle.

5. The auxiliary nozzle of claim 4, wherein an angle of inclination between the central axis of the port and the central axis of the auxiliary nozzle is between 25 degrees and 60 degrees.

6. The auxiliary nozzle of claim 4, wherein the inner surface of the cylindrical body defines a first opening of each of the plurality of ports and the outer surface of the cylindrical body defines a second opening of each of the plurality of ports, wherein the first opening is arranged proximate to the nozzle throat than the second opening.

7. The auxiliary nozzle of claim 1, wherein the plurality of ports is arranged in a single row.

8. The auxiliary nozzle of claim 1, wherein the plurality of ports is arranged in at least two rows.

9. The auxiliary nozzle of claim 8, wherein the plurality of ports is arranged in a staggered arrangement in the at least two rows.

10. The auxiliary nozzle of claim 8, wherein the plurality of ports is arranged in an in-line arrangement in the at least two rows.

11. A self-blast circuit breaker, comprising:
a stationary contact structure; and
a moving contact structure arranged to move in a longitudinal direction to engage and disengage with the stationary contact structure, the moving contact structure includes
a puffer cylinder having a first end and a second end, and defines a puffer chamber and a thermal expansion chamber arranged between the first end of the puffer cylinder and the puffer chamber and fluidly coupled to the puffer chamber to receive insulation gas from the puffer chamber,
a primary nozzle extending outwardly in the longitudinal direction from the first end of the puffer cylinder and arranged coaxially to the puffer cylinder, and
an auxiliary nozzle arranged inside the primary nozzle and defining a channel therebetween, the auxiliary nozzle extends outwardly in the longitudinal direction from the first end of the puffer cylinder, and includes a first end coupled to the puffer cylinder and a second end arranged distally from the puffer cylinder and inside the primary nozzle, the auxiliary nozzle comprises
a cylindrical body extending from the first end of the auxiliary nozzle towards the second end, the cylindrical body includes an outer surface and an inner surface defining a first elongated passage having a first diameter, and
a nozzle throat extending from the cylindrical body to the second end of the auxiliary nozzle, and having an inner surface defining a second elongated passage having a second diameter smaller than the first diameter,
wherein the cylindrical body defines a plurality of ports extending from the inner surface of the cylindrical body to the outer surface of the cylindrical body, the plurality of ports is arranged proximate to the nozzle throat, wherein the plurality of ports allows a flow of heated insulation gas from an inside of the auxiliary nozzle to the thermal expansion chamber through the channel.

12. The self-blast circuit breaker of claim 11, wherein the plurality of ports is arrayed circularly around a central axis of auxiliary nozzle.

13. The self-blast circuit breaker of claim 11, wherein a central axis of each of the plurality of ports extends perpendicularly to a central axis of the auxiliary nozzle.

14. The self-blast circuit breaker of claim 11, wherein a central axis of each of the plurality of ports is arranged at an inclination relative to a central axis of the auxiliary nozzle.

15. The self-blast circuit breaker of claim 14, wherein an angle of inclination between the central axis of the port and the central axis of the auxiliary nozzle is between 25 degrees and 60 degrees.

16. The self-blast circuit breaker of claim 14, wherein the inner surface of the cylindrical body defines a first opening of each of the plurality of ports and the outer surface of the cylindrical body defines a second opening of each of the plurality of ports, wherein the first opening is arranged proximate to the nozzle throat than the second opening.

17. The self-blast circuit breaker of claim 11, wherein the plurality of ports is arranged in a single row.

18. The self-blast circuit breaker of claim 11, wherein the plurality of ports is arranged in at least two rows and in a staggered arrangement.

19. The self-blast circuit breaker of claim 11, wherein the plurality of ports is arranged in at least two rows and in an in-line arrangement.

20. The self-blast circuit breaker of claim 11, wherein
the stationary contact structure includes a stationary arc contact, and
the moving contact structure includes a moving arc contact arranged coaxially inside the auxiliary nozzle, the moving arc contact includes a tip end arranged inside the cylindrical body at an offset from the nozzle throat, wherein the moving arc contact is adapted to contact and engage with stationary arc contact, closing an opening of the channel defined between the auxiliary nozzle and the primary nozzle,
wherein a first opening of one or more ports of the plurality of ports is disposed between tip end of the moving arc contact and the nozzle throat in a longitudinal direction.
